(19) United States
(12) Patent Application Publication
(10) Pub. No.: US 2023/0401174 A1
(43) Pub. Date: Dec. 14, 2023

(54) EXTENDING METADATA-DRIVEN CAPABILITIES IN A METADATA-CENTRIC FILESYSTEM

(71) Applicant: Dell Products L.P., Round Rock, TX (US)

(72) Inventors: Joel Christner, El Dorado Hills, CA (US); Robert A. Lincourt, Franklin, MA (US); Eric Bruno, Shirley, NY (US)

(21) Appl. No.: 17/806,773

(22) Filed: Jun. 14, 2022

(51) Int. Cl. G06F 16/182; G06F 16/16

(52) U.S. Cl. CPC G06F 16/183; G06F 16/16

(57) ABSTRACT

One example method includes declaring a management requirement for a collection of data, defining metadata that embodies the requirement, associating the management requirement with the collection of data, and performing a filesystem operation, with respect to the collection of data, based on the metadata. The declaring and defining operations may be performed by an administrator operating in a centralized datastore that includes a metadata repository, and the defined metadata may be stored in the metadata repository.

### RELATED APPLICATIONS

This application is related to (1) U.S. patent application Ser. No. ______ (attorney docket 16192.615), entitled NATIVE METADATA GENERATION WITHIN A STREAM-ORIENTED SYSTEM, and (2) U.S. patent application Ser. No. ______ (attorney docket 16192.616), entitled DYNAMIC FILESYSTEM GENERATION BASED ON CONTENT METADATA, both of which are filed the same day herewith, and both of which are incorporated herein in their respective entireties by this reference.

### FIELD OF THE INVENTION

Embodiments of the present invention generally relate to the use of content-specific metadata. More particularly, at least some embodiments of the invention relate to systems, hardware, software, computer-readable media, and methods for using content-specific metadata to declaratively alter filesystem handling of certain data.

### BACKGROUND

Currently, users lack a simple mechanism to declaratively specify how a particular file and its data should be handled by a filesystem. Approaches exist outside of the filesystem to extract important file data, store that data on alternative low-latency storage medium, or copy the data across multiple locations for caching and/or availability reasons. However, no method of natively, that is, within the filesystem, describing these needs exist, nor is there presently any filesystem implementation with the capability to enact these data management needs built-in.

In more detail, administrators lack a method and mechanism by way of which data of interest can be associated with files within a filesystem for users to describe how files and their data should be managed. Further, administrators and applications lack a method and mechanism to declare custom file and filesystem metadata.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment and architecture according to some embodiments of the invention.

FIG. 2 discloses aspects of an example method according to some embodiments of the invention.

FIG. 3 discloses aspects of an example computing entity operable to perform any of the claimed methods, processes, and operations.

### DETAILED DESCRIPTION OF SOME EXAMPLE EMBODIMENTS

Embodiments of the present invention generally relate to the use of content-specific metadata. More particularly, at least some embodiments of the invention relate to systems, hardware, software, computer-readable media, and methods for defining and using content-specific metadata to declaratively alter filesystem handling of specified data.

In general, some example embodiments of the invention may involve the use of a centralized metadata repository containing filesystem metadata and content metadata. Examples of such a centralized metadata repository are disclosed in the ‘Related Applications’ referred to herein. More specifically, by leveraging such a repository, an administrator may have the ability to perform various functions. One of such functions is declaring the data management needs of a file or group of files, possibly generated by a networked group of computer systems, where such data management needs may be defined in SLAs (service level agreements) and may include, for example, latency requirements, caching requirements, and availability/replication needs via filesystem metadata. Another of such functions is using the filesystem for the implementation of application extension of the metadata used by the filesystem itself.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment of the invention may enable a user to control the handling of user files in a filesystem by creating metadata concerning various file attributes, such as the way in which the files are to be handled, and associating the created metadata with those files. An embodiment may enable the definition and use of user-extended metadata for file handling and management. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of an Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, processes involving, but not limited to, the creation, modification, deletion, and management, of data and metadata.

New and/or modified data and metadata collected and/or generated in connection with some embodiments, may reside in a public or private cloud storage environment, an on-premises storage environment, and hybrid storage environments that include public and private elements. Any of these example storage environments, may be partly, or completely, virtualized. Some example cloud environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of computing environment.

In addition to the cloud environment, the operating environment may also include one or more clients or other entities that are capable of collecting, modifying, and creating, data. As such, a particular client may employ, or otherwise be associated with, one or more instances of each of one or more applications that perform such operations with respect to data. Such clients may comprise physical machines, or virtual machines (VM).

Note that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

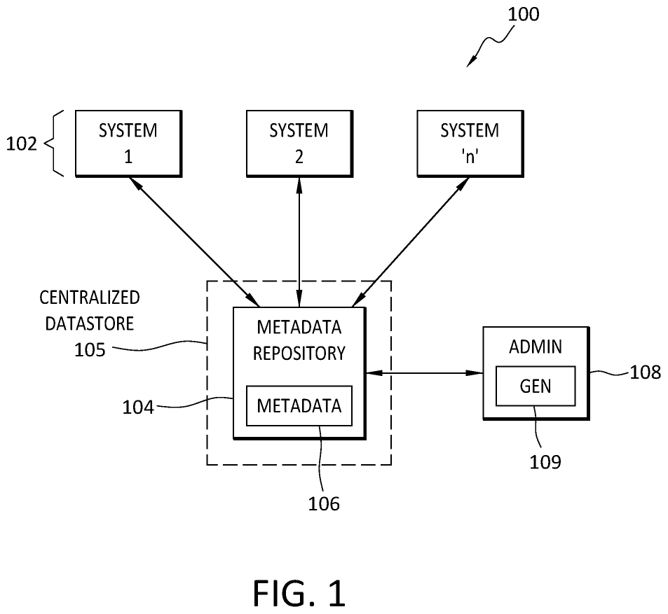

With particular attention now to FIG. 1, one example of an operating environment for embodiments of the invention is denoted generally at 100. In general, the operating environment 100 may comprise any number ‘n’ of systems 102 which, in general, may operate to generate, modify, delete, or replicate, data and metadata associated with that data. For example, the systems 102, which may be networked together with each other, may take the form of respective computing systems which may each comprise hardware and/or software, and which may include, for example, one or more applications that are executable to generate, modify, delete, or replicate, data and metadata associated with that data.

In connection with such data operations, one or more of the systems 102 may transmit new and modified metadata to a centralized metadata repository 104 which may or may not be integrated together with, or otherwise form a part of, a centralized datastore 105. In some embodiments, the metadata repository 104 may comprise one or more databases which may store metadata 106 and are operable to respond to queries by providing any metadata responsive to such queries. The metadata repository 104 may be controlled and administered by an administrator 108 which may, or may not, comprise an administrator application that may be separate from, or integrated together with, the metadata repository 104. Note that any of the functions, processes, and operations, disclosed herein as being performed by an ‘administrator’ may be performed by, or at the direction of, such an administrator application. The administrator 108 may be part of a network that includes the systems 102 and the centralized datastore 105.

The administrator 108 may include a module 109 which may be operable to, among other things, create and manage metadata associated with data in the centralized datastore 105. Particularly, the module 109 may be operable to declare data management needs for data, such as a file stored in the centralized datastore 105, and to enable the extension of basic file metadata, which may comprise content-based metadata stored at the metadata repository 104, to include metadata employable by a centralized datastore 105, which may comprise the metadata repository 104 as one of its elements, in the management of the data. In this regard, it is noted that the centralized datastore 105 may further comprise a filesystem that stores files, folders, and other content, whose metadata may be stored in the metadata repository 104.

As noted, the metadata repository 104 may store metadata 106 and may transmit metadata in response to queries. Such queries may be transmitted by one or more of the systems 102. Thus, an entity that contributes metadata to the metadata repository 104 may, or may not, also be a consumer of metadata stored, by that entity and/or one or more other entities, at the metadata repository 104.

### B. User-Defined Metadata

Among other things, example embodiments of the invention may implement the generation and use of user-defined metadata not currently existing or employed in connection with the management of content such as files, folders, and other data. Typical metadata may comprise, for example, file name, path, file attributes, timestamps, content length attributes, last write timestamp, last access timestamp, and keywords. While useful in some contexts, this metadata, that is, conventional content-based metadata and filesystem metadata, may not particularly well suited for use in data management operations such as file handling and file management.

Thus, embodiments of the invention may provide for the generation and use of a particular class of metadata, namely, user-defined metadata. For example, the user-defined metadata may comprise metadata other than conventional content-based metadata and filesystem metadata. Further, user-defined metadata may or may not comprise content-based metadata, and/or filesystem metadata. Particularly, example embodiments may enable an administrator to define both new metadata, along with a description of how a file and its data are affected when the specified user-defined metadata is associated with the file and/or its data.

By way of illustration, such user-defined metadata may comprise a series of properties that a user may want to add on to the list of conventional metadata. These properties, or user-defined metadata, may also be referred to herein as ‘user-extended metadata’ inasmuch as this metadata may constitute an extension of, or supplement to, the metadata conventionally associated with data such as files and folders. Moreover, the user-defined metadata may differ from conventional metadata at least in that the user-defined metadata may not be automatically generated by a filesystem but may, instead, be defined, and used, by an administrator according to user instructions and based on user preferences.

Thus, in example embodiments, the administrator may have the ability to declare data management needs for a file, where the data management needs may include, for example, SLA requirements such as latency parameters, caching, and other requirements. That file may already have other associated metadata such as file name, attributes, timestamps, and keywords. According to some example embodiments, the user may add, to the other conventional metadata, an attribute for an SLA level, or the user may add an attribute defining a data management attribute of the file such as, but not limited to, a latency requirement, a caching requirement, or a replication requirement, for that individual file. In this way, a user may extend the metadata already associated with the file by adding one or more data management attributes to that metadata. As another example, a user may add user-defined data management metadata indicating that a file is critical enough to be replicated to another server, while other files may not have that metadata associated. Following is an illustration of the application of an example embodiment of the invention.

Consider the example of an automotive company that would like to add an annotation to every file that indicates the model of the car that the file is related to. In this example, the company, Toyota for example, might add a property, that is, user-defined metadata, called ‘model’ and the value of that metadata could be a vehicle name such as ‘Highlander,’ ‘Supra,’ or ‘Camry’ for example. User-defined metadata may comprise a single value, or may comprise an array of values such as, in connection with the foregoing illustrative example, [‘Supra’+‘GT’].

### C. Operational Aspects of Some Example Embodiments

Example embodiments embrace an approach that may comprise using content-specific metadata to declaratively alter filesystem handling of data. Thus, some embodiments may employ user-defined metadata that may be used to affect the behavior of the filesystem management of the data of a file. In some embodiments, the centralized metadata for a file within a filesystem may be extended by the user. Leveraging a centralized metadata repository containing filesystem metadata and content metadata may enable an administrator to (1) declare the data management needs and requirements of a dataset, such as a file, including SLA parameters such as latency requirements, caching requirements, and availability/replication needs, by way of filesystem metadata, and (2) use a filesystem, such as is disclosed in the ‘Related Application's referred to herein, to enable administrator, and application, extension of the metadata used by the filesystem itself.

### C.1 SLA Parameters

Data management parameters such as SLA requirements of files and folders, and other data, of interest may be declared using filesystem metadata, whereby, for example, the filesystem may use built-in facilities to store the file in the proper storage medium and location to meet these SLAs. Further, based on user-defined metadata for the file, or at specific regions within the file data, the file or the applicable data of the file may be replicated across computer nodes and/or geographic locations for the purposes of caching and high availability.

### C.2 Data Management

Example embodiments may enable administrators to declaratively define how a file, of a portion of data in the file, should be handled, for example in terms of privacy and security, via user-defined filesystem metadata. For example, user-defined metadata may be employed to inform the filesystem that the file or data in the file should not be replicated to an external destination such as a public cloud, outside of the company network, or beyond the geographic region specified in the metadata. The user-defined metadata may be stored in a metadata repository, and associated with the corresponding data.

### C.3 Example Use Case

Suppose that there is a group of computers connected to a common network. A cloud filesystem, for example, may be presented to the operating system of one or more of the computers by a filesystem driver, examples of which are disclosed in the ‘Related Applications,’ to be consumed by users and applications, that may be identical in appearance to a local filesystem. However, the metadata from the filesystem, which may comprise primitive filesystem metadata and content-specific metadata, may be persisted in a remote datastore, enabling global discovery of data across the series of computers from a single console, such as an administrator for example. In example embodiments of the invention, the behavior of the filesystem management of the associated file and its data may be guided by the use of user-defined metadata associated with the file itself, or within regions of the file.

### D. Example Methods

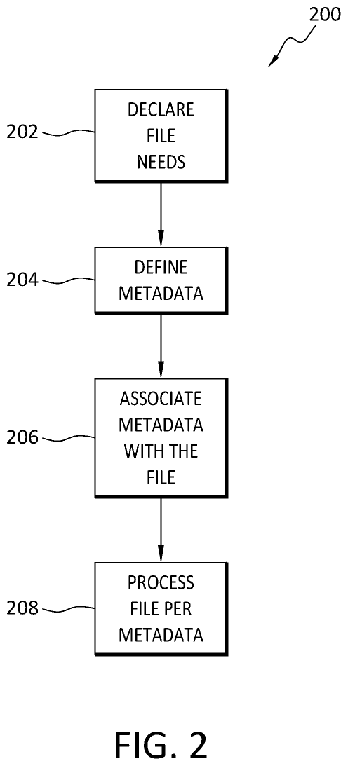

It is noted with respect to the disclosed methods, including the example method 200 of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, an example method 200 is disclosed for the creation and use of user-defined metadata. The user-defined metadata may or may not comprise filesystem metadata. The method 200 may be performed with respect to a file, a portion of a file, a folder comprising a group of files, or any other collection or grouping of data. In some instances, the method 200 may be performed within a centralized datastore that is networked together with various systems that may operate to generate new and modified data. Within the centralized datastore, the method 200 may be performed by an administrator. The foregoing considerations are presented only by way of example however, and are not intended to limit the scope of the invention in any way.

The example method 200 may begin when an administrator, or a data owner, declares 202 one or more requirements for the handling of a file, or other data. By way of illustration, the administrator may determine 202 that the file should not be sent to any computing system not part of a company VPN.

Based on the requirement(s) included in the declaration, the administrator may then, either on its own and/or based on input from the file owner, define and generate metadata 204 that embodies those requirements. The metadata that is defined 204 need not take any particular form. In this illustrative, but non-limiting example, the metadata comprises filesystem metadata inasmuch the metadata concerns filesystem operations, that is, how the file will be handled by the filesystem.

After the metadata has been defined and generated 204, the metadata may then be associated 206 with the file. The association 206 of the metadata with the file may be performed in any way that enables the filesystem to be aware of, access, and act according to, the metadata. The metadata may be stored in a metadata repository and may or may not be accessible by the entities in a network that includes a centralized datastore and computing entities.

Finally, when the filesystem is requested to perform an operation concerning the file, the filesystem may consult the metadata relating to that file, and then process the file 208 according to the requirements embodied in the metadata. As used herein, filesystem operations are intended to be broad in scope and may include, but are not limited to file operations such as read, write, delete, replicate, and move. As also noted herein, such filesystem operations may include or imply SLA requirements such as, but not limited to, latency requirements, caching requirements, and availability/replication needs.

### E. Further Example Embodiments

Following are some further example embodiments of the invention. These are presented only by way of example and are not intended to limit the scope of the ° invention in any way.

Embodiment 1. A method, comprising: declaring a management requirement for a collection of data; defining metadata that embodies the requirement; associating the management requirement with the collection of data; and performing a filesystem operation, with respect to the collection of data, based on the metadata.

Embodiment 2. The method as recited in embodiment 1, the method is performed by an administrator at a centralized datastore that is accessible by a group of computing systems that are networked together with each other.

Embodiment 3. The method as recited in any of embodiments 1-2, wherein the method is performed in a centralized datastore that includes a metadata repository in which the metadata is stored.

Embodiment 4. The method as recited in any of embodiments 1-3, wherein the management requirement concerns how the data will be handled by a filesystem that performs the filesystem operation.

Embodiment 5. The method as recited in any of embodiments 1-4, wherein the metadata is defined by a user and/or an administrator, and not by a filesystem that performs the filesystem operation.

Embodiment 6. The method as recited in any of embodiments 1-5, wherein the management requirement is specified in a service level agreement.

Embodiment 7. The method as recited in any of embodiments 1-6, wherein the metadata comprises filesystem metadata, but no content-specific metadata.

Embodiment 8. The method as recited in any of embodiments 1-7, wherein the data collection is also associated with content-specific metadata and/or filesystem metadata.

Embodiment 9. The method as recited in any of embodiments 1-8, wherein the declaring is performed by a user and/or an administrator.

Embodiment 10. The method as recited in any of embodiments 1-9, wherein the defining is performed by a user and/or an administrator.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

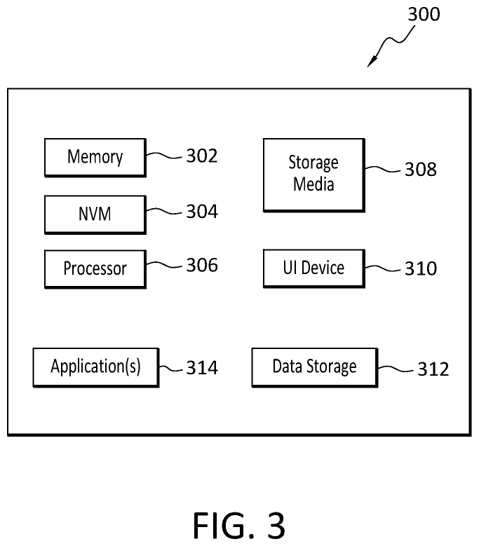

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI (user interface) device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
declaring a management requirement for a collection of data;
defining metadata that embodies the requirement;
associating the management requirement with the collection of data; and
performing a filesystem operation, with respect to the collection of data, based on the metadata.

2. The method as recited in claim 1, wherein the method is performed in a centralized datastore that is accessible by a group of computing systems that are networked together with each other.

3. The method as recited in claim 1, wherein the method is performed in a centralized datastore that includes a metadata repository in which the metadata is stored.

4. The method as recited in claim 1, wherein the management requirement concerns how the data will be handled by a filesystem that performs the filesystem operation.

5. The method as recited in claim 1, wherein the metadata is defined by a user and/or an administrator, and not by a filesystem that performs the filesystem operation.

6. The method as recited in claim 1, wherein the management requirement is specified in a service level agreement.

7. The method as recited in claim 1, wherein the metadata comprises filesystem metadata, but no content-specific metadata.

8. The method as recited in claim 1, wherein the data collection is also associated with content-specific metadata and/or filesystem metadata.

9. The method as recited in claim 1, wherein the declaring is performed by a user and/or an administrator.

10. The method as recited in claim 1, wherein the defining is performed by a user and/or an administrator.

11. A non-transitory storage medium having stored therein instructions that are executable by one or more hardware processors to perform operations comprising:
declaring a management requirement for a collection of data;
defining metadata that embodies the requirement;
associating the management requirement with the collection of data; and
performing a filesystem operation, with respect to the collection of data, based on the metadata.

12. The non-transitory storage medium as recited in claim 11, wherein the operations are performed in a centralized datastore that is accessible by a group of computing systems that are networked together with each other.

13. The non-transitory storage medium as recited in claim 11, wherein the operations are performed in a centralized datastore that includes a metadata repository in which the metadata is stored.

14. The non-transitory storage medium as recited in claim 11, wherein the management requirement concerns how the data will be handled by a filesystem that performs the filesystem operation.

15. The non-transitory storage medium as recited in claim 11, wherein the metadata is defined by a user and/or an administrator, and not by a filesystem that performs the filesystem operation.

16. The non-transitory storage medium as recited in claim 11, wherein the management requirement is specified in a service level agreement.

17. The non-transitory storage medium as recited in claim 11, wherein the metadata comprises filesystem metadata, but no content-specific metadata.

18. The non-transitory storage medium as recited in claim 11, wherein the data collection is also associated with content-specific metadata and/or filesystem metadata.

19. The non-transitory storage medium as recited in claim 11, wherein the declaring is performed by a user and/or an administrator.

20. The non-transitory storage medium as recited in claim 11, wherein the defining is performed by a user and/or an administrator.
